(19) United States
(12) Patent Application Publication
(10) Pub. No.: US 2007/0177166 A1
(43) Pub. Date: Aug. 2, 2007

(54) Image processing apparatus, an imaging system, a computer program and a method for scaling an object in an image

(75) Inventors: Raymond Joseph Elisabeth Habets, Eindhoven (NL); Rutger Nijlunsing, Eindhoven (NL)

Correspondence Address: PHILIPS INTELLECTUAL PROPERTY & STANDARDS, 595 MINER ROAD, CLEVELAND, OH, 44143, US

(73) Assignee: KONINKLIJKE PHILIPS ELECTRONICS, N.V., EINDHOVEN (NL)

(21) Appl. No.: 11/569,600

(22) PCT Filed: May 25, 2005
(86) PCT No.: PCT/IB05/51705

§ 371 Date: Nov. 27, 2006

(30) Foreign Application Priority Data
May 28, 2004 (EP) 04102404.3

(51) Int. Cl. G06K 15/02

(52) U.S. Cl. 358/1.2; 358/451

(57) ABSTRACT

The invention relates to an image processing apparatus arranged to scale an object within an image, said image processing apparatus comprising a calibrator arranged to scale the object based on a calibration factor derived from a relationship between a true dimension of a marker and a dimension of the marker in pixel units in the image, wherein the calibrator is further arranged to generate a plurality of calibration factors obtained using a plurality of differently oriented markers identified within said image. The image I comprises a plurality of objects (3, 8, 9) which are oriented differently in space resulting in a different alignment of these objects with respect to the anatomical structures (2). The object (3) is linked to a measurement tool, which is arranged to measure a length of the object (3) in pixel units and to calculate a true length of the object (3) using a calibration factor determined from a marker (A), which has a similar alignment in space as the object (3). The image (1) further comprises objects (8, 9), linked to a measurement tool, which is arranged to calculate a true length of the objects (8, 9) based on respective lengths of these object in pixel units and a calibration factor determined using the marker (B). Preferably, the objects corresponding to a different marker are grouped to form a calibration group, whereby an update in the calibration factor results in an automatic update of true dimensions for all objects within the same calibration group. Preferably, each calibration group is identified differently for user's convenience. The invention further relates to an imaging system, a computer program and a method for enabling scaling of objects in the image.

The invention relates to an image processing apparatus arranged to scale an object within an image, said image processing apparatus comprising:

a calibrator operable to scale the object based on a calibration factor derived from a relation between a true dimension of a marker and a dimension of the marker in pixel units in the image.

The invention further relates to an imaging system.

The invention still further relates to a method for enabling scaling of an object within an image.

The invention still further relates to a computer program.

An embodiment of an image processing apparatus as is set forth in the opening paragraph is known from U.S. Pat. No. 6,405,071. The known image processing apparatus is arranged to determine a length of a root canal from an X-ray image thereof, said image comprising a projection of a marker aligned with the root canal. The marker has a pre-known length and is used for calibration purposes. Thus, a relationship, notably a ratio between a length of the marker in pixel units and its true length yields an image calibration factor. The measured length of the root canal will be scaled according to its length in pixel units and the calibration factor.

It is a common practice to use a sole marker for determination of the image calibration factor. For this purpose a user manually delineates the marker, for example by indicating two points for a length measurement, using a suitably arranged graphic user interface and executes a suitable computation routine for a determination of the length of the marker in pixel units. When said length of the calibration marker is determined, the user manually enters the true dimension of the marker so that a suitable calibrator of the image processing apparatus calculates the calibration factor.

It is a disadvantage of the known image processing apparatus that a separate data acquisition is required for the calculation of the individual calibration factors for each object when those objects are oriented differently from each other in the same image.

It is an object of the invention to provide an image processing apparatus wherein scaling of differently oriented objects is enabled based on the same data set.

To this end in the image processing apparatus according to the invention the calibrator is further arranged to generate a plurality of calibration factors obtained using a plurality of differently oriented markers identified within said image.

The technical measure of the invention is based on the insight that by providing a plurality of calibration factors for differently oriented objects within the image a simultaneous calibration of these objects can be enabled, whereby these calibration factors are assigned not to the image, but are linked to the objects having the same spatial orientation as a corresponding marker. In this way it is not necessary to acquire a plurality of image data covering for a plurality of necessary calibration factors, thus improving a process of data acquisition and post-processing. It must be noted, that for the marker either an artificial object with a pre-known true dimension, or a part of the image, notably a medical image, comprising areas with known dimensions may be used.

In an embodiment of the image processing apparatus according to the invention, the image processing apparatus further comprises a linker arranged to form groups each comprising at least one object linked to a respective marker.

It is found to be particularly advantageous to interrelate a plurality of objects for calibration purposes. This measure has an advantage that in case when a calibration factor of a given group is updated, for example due to a user interaction, the true dimension of every object within the group is automatically updated. This feature further improves a user-friendliness and a reliability of the image processing apparatus according to the invention. It is considered to be advantageous to divide the differently oriented objects into a suitable number of calibration groups, whereby, for example, similarly oriented objects are linked to a similarly oriented marker thus sharing the same calibration factor. Selection of the marker to which the objects are linked can be carried out manually. In this case the user selects the objects within the group and links them to the suitable marker using suitable graphic interactive tools. Preferably, the selection of the marker is enabled automatically, whereby, for example, an a-priori information about structures in the image is used. For example, for anatomical structures a per se known pattern recognition engine may be used, or, alternatively, an information available from another image, like results of a suitable image segmentation step.

In a further embodiment of the image processing apparatus according to the invention, said apparatus further comprises a visualizer arranged to indicate each of said groups independently.

Preferably, different groups are indicated the visualizer by assigning different colors to the objects and the marker constituting different groups. Alternatively, it is possible to use different indicators for different groups, like suitable alpha-numerical information. Still alternatively, it is possible to use different attributes for objects and markers of different groups, like line formatting, shading, overlays, etc. Due to this technical measure the user is provided with a better insight into the orientation of the objects forming the image, so that there is little space for mistakably assigning a calibration factor to an object from a different calibration group.

In a still further embodiment of the image processing apparatus according to the invention the calibrator is further arranged to overlay said image with a graphic template of the marker, said graphic template being linked to a measurement tool for measuring of the dimension of the marker in pixel units.

This technical feature is based on the insight that it is advantageous to allow the user to manipulate a graphic object provided with an associated measurement, which is available in the image for calibration purposes. It must be understood that within the terms of the current invention, the term ‘marker’ is attributed to any graphic object suitable for calibration purposes. For example, the marker may comprise two landmarks, a line between two landmarks, a circle with a diameter or a radius, or any other suitable one- or multi-dimensional object comprising a plurality of pixels. Additionally, the marker may be obtained from a suitable image segmentation step, which is arranged to provide a suitable shape, for example, positioned on top of a specific part of an anatomy or an object shown in the image.

According to this feature, the calibrator is arranged to overlay the image with the graphic template of the marker linked to the associated tool enabling measurement of the dimension of the marker in pixel units. Thus, the user does not have to manually delineate the marker, which improves the accuracy and reliability of the calibration step. Suitable graphic routines operable to calculate the dimension in pixel units are known per se in the art. Preferably, if the image processing apparatus according to the invention is used for a certain type of images, for example for planning an implant, the graphic template may comprise a true length of the marker, the user having only to confirm the used marker true length, or, otherwise, to edit it accordingly. Upon a completion of the calibration step, the true dimension of the object will be determined with high precision and without a substantial user interaction. It is found to be preferable that the graphic template not only provides a suitable marker, but also automatically calculates its dimension in pixel units. A plurality of suitable measurement tools are known per se in the art, the examples comprising any suitable shape with an associated measurement function.

In a further embodiment of the image processing apparatus according to the invention the measurement tool is defined within a geometric relational application framework macro.

This technical measure is advantageous, as the graphic relational application macro can be configured to interrelate a plurality of objects in such a way, that when a single object is repositioned, the other objects related to it are repositioned accordingly. This results not only in a provision of a fully automated image processing, but also in a provision of a highly reliable delineation, measurement and calibration means.

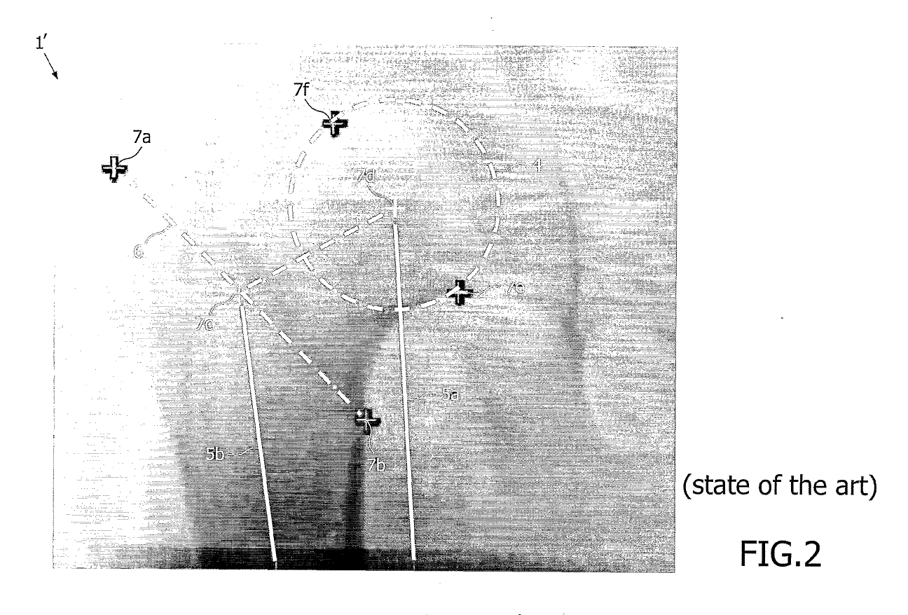

An embodiment of the image handling using the geometric relational application framework macro is known from WO/0063844, which is assigned to the present Applicant. The geometric application framework macro is arranged to provide detailed descriptions of various geometric templates defined within the image, in particular to structurally interrelate said templates within geometry of the image, thus providing a structural handling of various geometrical templates so that a certain pre-defined geometrical consistency between the templates is maintained. The geometric application framework macro further enables analysis and/or measurement of geometrical properties of anatomical structures, when the structure is provided with a suitable landmark. A broad variety of possible geometric relations between pre-definable geometric templates, like a circle, a line, a sphere, etc., is possible and is defined within the geometric application framework macro. The geometric template is operable by the geometric application framework macro using a landmark, or a set of landmarks associated with the geometric template. FIG. 2 shows an embodiment of the known geometric template controllable by the geometric application framework macro which is arranged to define geometrical relations between a plurality of geometric templates.

An imaging system according to the invention comprises a display and the image processing apparatus, as is set forth in the foregoing. Advantageously, the imaging system according to the invention further comprises a data acquisition unit connectable to the image processing apparatus. In this way an easy to operate data acquisition and processing system is provided, whereby the user is enabled to carry out necessary image processing steps with high reliability.

A method according to the invention comprises the steps of:

identifying a plurality of differently oriented markers within the image;

for each marker calculating a calibration factor based on a relation between a true dimension of the marker and a dimension of the marker in pixel units;

generating a plurality of the calibration factors.

According to the method of the invention, it is possible to use a single image for scaling a plurality of objects using a plurality of calibration factors assigned to different objects. For example, such an image may comprise differently oriented objects in space, each requiring a separate calibration factor for scaling purposes. Alternatively or additionally, such an image may comprise paste areas with zoom-ins or zoom-outs requiring a different calibration factor due to a different magnification factor. By providing a plurality of calibration factors, which are assigned not to the image as a whole, but to separate objects within the image, a scaling procedure for the objects requiring different calibration factors is simplified. Further advantageous embodiments of the method according to the invention are set forth in claims 9-12.

The computer program according to the invention is arranged to cause a processor to carry out the steps of the method as is set forth in the foregoing. The computer program comprises suitable subroutines arranged to load image data and to run a measurement protocol. Upon an event the suitable plurality of markers is identified in the image, either by user interaction or automatically, the computer program initiates a measurement protocol for determining a dimension of each marker in pixel units. The measurement protocol is arranged to initiate a toolkit macro that contains a marker. Preferably, the marker is positioned on the image using suitable image matching techniques. For example, when the user selects a marker to be represented by a standard geometric shape, for example a circle or a line, the matching subroutine carries out an automatic matching between a part of the image and the marker, by suitably sizing and displacing the marker. When the calibration factors are determined, they are stored with reference to the marker for which they are calculated. The calibration routine further applies the thus determined calibration factors to the objects linked to them. The user may alter the value of the true size of the markers, the calibration and scaling being updated automatically.

These and other aspects of the invention will be explained in more detail with reference to the figures.

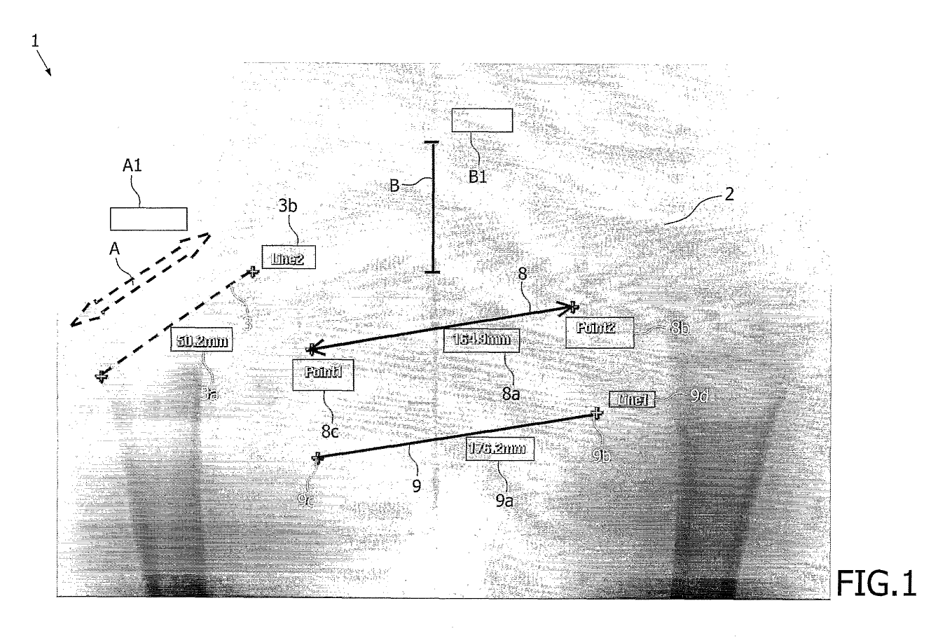

FIG. 1 presents in a schematic way an embodiment of an image comprising differently oriented objects.

FIG. 2 present in a schematic way an embodiment of a geometric relational application framework macro (state of the art).

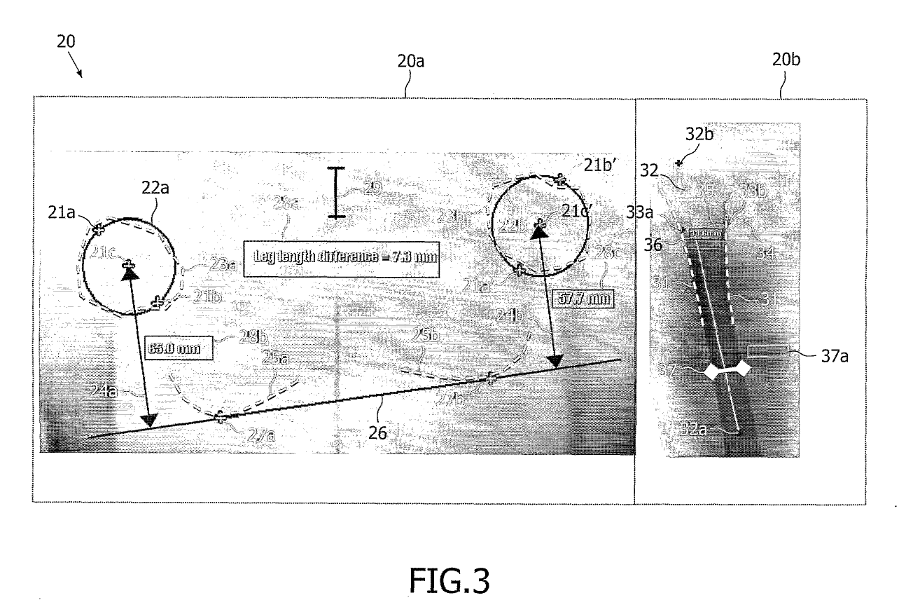

FIG. 3 presents in a schematic way an embodiment of an image whereby a geometric relational application framework macro is used for defining the markers in the image.

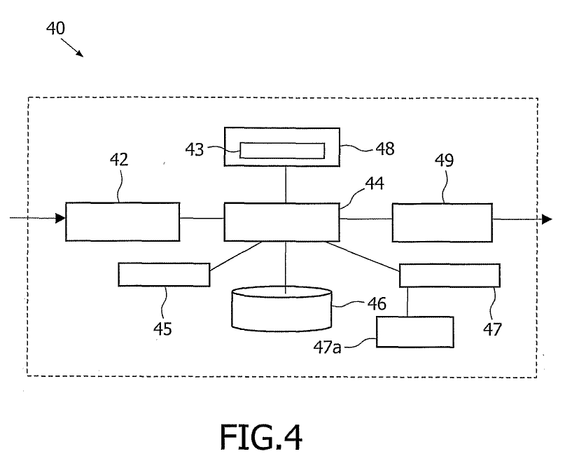

FIG. 4 presents in a schematic way an embodiment of an image processing apparatus according to the invention.

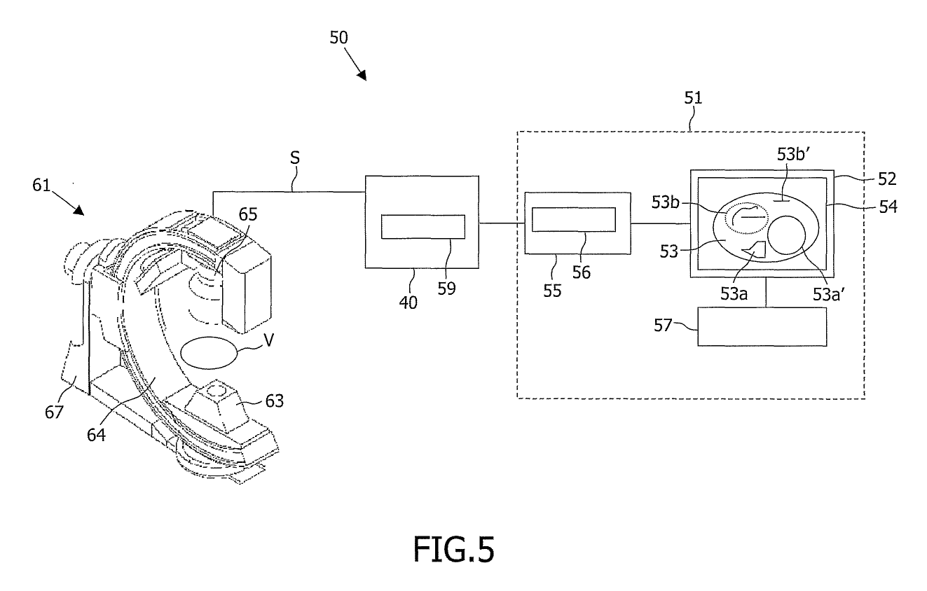

FIG. 5 presents in a schematic way an embodiment of an imaging system according to the invention.

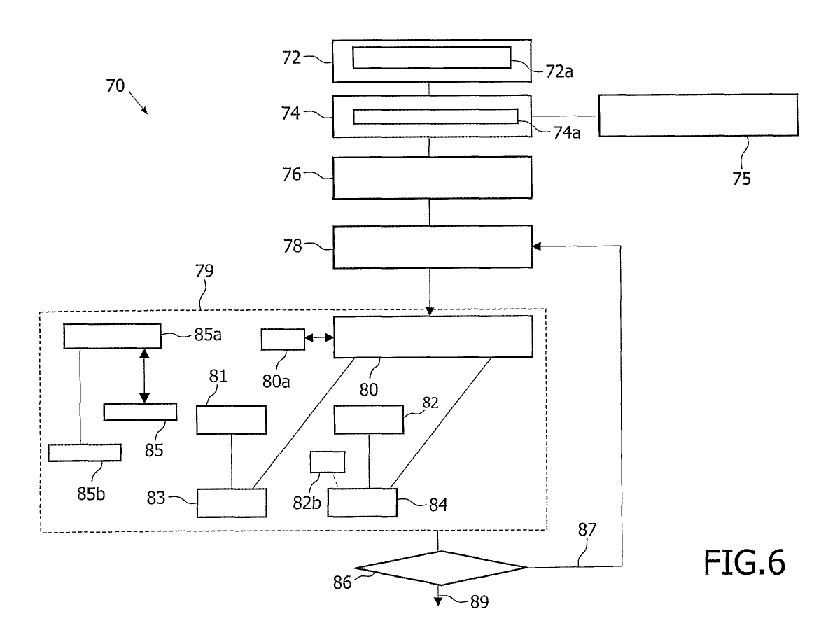

FIG. 6 presents in a schematic way an embodiment of a workflow of a method according to the invention.

FIG. 1 presents in a schematic way an embodiment of an image comprising differently oriented objects. In this example a diagnostic image 1 comprising information on spatial interrelationship of anatomical structures 2 is selected. Other possible images, not related to a medical domain are contemplated as well. As is schematically shown in this Figure, the image 1 comprises a plurality of objects 3, 8, 9 which are oriented differently in space resulting in a different alignment of these objects with respect to the anatomical structures 2. In this example the object 3 is defined as a graphic line object 3b, which is linked to a measurement tool (not shown). The measurement tool is arranged to measure a dimension in pixel units of the object 3 and to calculate a true length of the object 3 using a calibration factor determined from a marker A, which has a similar alignment in space as the object 3. Preferably, the marker A is defined using a suitable object in the image, for example a measuring instrument, like a caliper or a screw with known dimensions. The image 1 further comprises object 8 which is defined as a graphic distance object between two landmarks 8b and 8c. The object 8 is also linked to a measurement tool (not shown), which is arranged to calculate a true length of the object 8 based on a length of this object in pixel units and a calibration factor determined using the marker B. The corresponding true length of the object 8 is preferably given in a window 8a. The object 9 is defined as a graphic line object 9d between two landmarks 9b and 9c, whereby this object is also linked to a measurement tool arranged for determining a true length of this object based on the calibration factor obtained using the marker B. The corresponding true length of the object 9 is preferably given in a window 9a. It must be noted that preferably all objects and markers within the image are linked to a sole measurement tool, which is implemented as a suitable computer program. Preferably, the true length of the object 3 is fed-back in a suitable graphic window 3a. It is seen, that the objects 3, 8, 9 are linked to different respective markers A, B, which respectively are aligned in space in a similar fashion as the objects 3 or 8, 9. It must be understood that a spatial alignment refers to an alignment with respect to a certain plane, rotations within the plane are allowable. Thus, the marker B is rotated with respect to the objects 8, 9 which correspond to the same plane as the marker B. Preferably, true lengths of the markers are fed back in respective graphic windows A1, B1. These dimensions are read out using a suitably arranged interface and are made available to the calibration routine. Still preferably, these graphic windows can be interacted with to edit the true length of any of the markers. By coupling the calibration factor to the objects within the image instead to the image as a whole, a calibration of differently oriented objects in space is enabled using a sole image, thus improving a workflow of image acquisition and post-processing. It must be noted, that all objects shown in the image together with the markers may be delineated manually or in a fully automated fashion. In a latter case a user-friendliness of the image processing system is further increased. Preferably, the objects corresponding to a different marker are grouped to form a calibration group, whereby an update in the calibration factor will result in an automatic update of true dimensions for all objects within the same calibration group. Preferably, each calibration group is identified differently for user's convenience. In this example different line styles are shown to differentiate between objects and markers from different groups. Alternatively, a color coding or suitable labeling may be applied.

FIG. 2 presents in a schematic way an embodiment of a known two-dimensional geometric relational application macro 1′, which is arranged to define geometrical relations for the geometric templates 4, 5a, 5b, 6. The known graphic application framework macro is further arranged to maintain the defined geometrical relations once any geometrical template is repositioned. The respective geometrical templates are defined using respective associated landmarks 7a, 7b, 7e, 7f. The geometric application framework macro can also be arranged to operate a three-dimensional geometric template (not shown).

FIG. 3 presents in a schematic way an embodiment of an image whereby a geometric relational application framework macro is used for defining the markers in the image. In this example the image 20 comprises regions with different magnification factors 20a, 20b, each region comprising at least one calibration marker 29, 37 for calibration purposes. This particular embodiment illustrates an application 20a related to a measurement of a leg length difference based on an X-ray image and an image 20b showing a femur bone of the same individual. Any suitable implementation for associating geometric objects in the image 20 is possible, including, but not limited to a geometric relational application framework macro. Any other suitable image from any other suitable imaging modality may as well be used for practicing the invention. The objects inter-related by the geometric relational application macro comprise two circles 22a, 22b arranged for modeling of size and position of corresponding femoral heads, and a line 26 arranged for indicating the base of the pelvis. Distances from both circle centers 21c, 21c′ to this baseline 28b, 28c are also part of the geometric relational application macro structure and are calculated automatically, using the same calibration factor (not shown) obtained from a suitable marker (not shown). Therefore, the difference between the distances 24a, 24b representing the leg length difference is also obtained automatically with high precision.

If one element (circle 22a or line 26) is modified all other elements are automatically updated to reflect this modification. Also, in case the true length of the marker 29 is modified, the measurement of the leg length is updated instantly. According to the technical measure of this embodiment of the invention, objects 23a, 23b, 25a, 25b are associated with respective graphic objects 22a, 22b, 26. These graphic objects are arranged to position themselves automatically along edges or other features of the image data. Through specifically defined relations between graphic objects 22a, 22b, 26 inter-related by the geometric relational application macro and the graphic objects 23a, 23b, 25a, 25b, the circles 22a, 22b are positioned to fit optimally to the paths of the closed contours 23a, 23b, while the straight line 26 is positioned such that it touches both open contours 25a, 25b. The graphic template is thus coupled, so that adaptations of the circles 22a, 22b, or the straight line 26 are automatically reflected in the measured distances 28a, 28b, 28c. Preferably, the constraints and relations that exist between the geometric objects are arranged to limit the adaptation of these objects, which is in turn automatically translated into limitations for the adaptation of the multi-dimensional graphic objects. Such constraints are preferably based on knowledge of anatomical consistency.

In image 20b the inter-related objects comprise lines 32, 34 modeling the femur bone and a measurement tool 35. In this example an automatic diameter measurement of a human femur is shown. The solid lines 32, 34 represent graphic templates within the geometric relational application macro: a line 32 modeling the femoral axis, a second perpendicular line 34 modeling a direction of a diameter measurement 35. This perpendicular line 34 is arranged to contain two graphic templates, namely two point objects 33a, 33b with an associated distance measurement, all being defined within the geometric relational application macro. In this example, open contours 31 are associated with the points 33a, 33b. These contours position themselves automatically along the edges of the femoral bone using a suitable image segmentation technique. Through specifically defined relations between the line 34, the line 32 and the contours 31, the positions of the two point objects 33a, 33b are automatically adapted to the intersection of the perpendicular line 34 and each graphic object 31. The image 30 further comprises a marker 37, which is used for calibration purposes. A corresponding calibration factor or a true length of the marker is fed-back to the user in the window 37a. In case when the calibration factor of the marker is changed, for example due to editing of the true length of the marker, the reading of the true distance 36 is updated automatically. Also, the reading of the true distance 36 is automatically updated in case when a position of any of the lines 31, 32, 34 is changed, leading to a different reading of a length for a trajectory 35 between new points 33a and 33b in pixel units. Thus, in case when the user picks up the perpendicular line 34 and moves it along the femoral axis, the diameter measurement 35 will adapt dependent on the current femur diameter at a new location of the perpendicular line 34. According to this technical measure, a versatile and easy to operate image processing means is provided, whereby due to coupling between the graphic objects in a geometric relational application macro, any repositioning of the objects automatically lead to an update of the true dimension of the object of interest 35.

Although in this example it is clear for the user which regions of the image use which marker, it is preferable that the objects are combined in groups linked to a respective marker. Preferably, each group is visualized differently using suitable graphic means. Although an operation of the geometric relational application framework macro is illustrated using this particular example, whereby an image comprising two parts with different magnification factors is shown, it is possible that further groups are defined within each sub-area 20a, 20b, for objects which have different spatial orientation, as is described with reference to FIG. 2.

FIG. 4 presents in a schematic way an embodiment of an image processing apparatus according to the invention. The image processing apparatus 40 has an input 42 for receiving the image data in any suitable form. For example, the apparatus 40 may be involved in the acquisition of the image data. In this case the image data may be acquired in an analogue form and converted using a suitable A/D converter to a digital form for further processing. The image data may also be received in a digital form, e.g. through direct acquisition in a digital form or via a computer network after having been acquired by another computer/medical instrument. The core of the image processing apparatus is formed by a processor 44, such as a conventional microprocessor or signal processor, a background storage 48 (typically based on a hard disk) and working memory 46 (typically based on RAM). The background storage 48 can be used for storing the image data (or parts of it) when not being processed, and for storing operations of the graphic template and suitable shape models (when not being executed by the processor). The main memory 46 typically holds the (parts of) the image data being processed and the instructions of the geometric template and the models used for processing those parts of the image data. The apparatus 40 according to the invention comprises a calibrator 45 arranged to generate respective calibration factors based on a plurality of the markers in the image. The linker 47 is used for associating the markers and the objects with a suitable computation routine for determination of respective dimensions in pixel units. The linker 47 may also be used to form calibration groups for a plurality of objects within the image. Still preferably, the linker 47 is arranged to communicate with a visualizer 47a arranged to visualize different groups in a different way. For example, different line attributes may be used for lines delineating the objects and markers, whereby like line attributes are assigned to members of one group. Alternatively, suitable color coding may be applied. Still alternatively suitable alpha-numerical tags may be assigned for each group thus differentiating between them. Preferably, the calibrator 45, the linker 47 and the visualizer 47a are operable by a computer program 43, preferably stored in memory 48. An output means 49 is used for outputting the result of the calibration. For example, if the processor 44 has been loaded with a segmenting program, for example retrieved from the storage 48, then the output may be a segmented structure with an identifiable marker provided with a corresponding calculation of the dimension in pixel units, which is, for example visually indicated on a suitable display means (not shown). Preferably, the output comprises a result of the associating of the marker with a suitable calibration routine. For example, a default true length of the marker may be used for calibration purposes. The user is then prompted whether he wishes to accept the calibration factor or to edit the true length of the marker. Alternatively, the user may input the true dimension of the marker using suitable input means. For example, a file reader may be used to input a pre-stored value of the true dimension of the marker. It is further possible to use a suitable user interface, like a graphic interface or a text editor to input the value of the true dimension of the marker.

FIG. 5 presents in a schematic way an embodiment of the imaging system according to the invention. The imaging system 50 according to the invention comprises the image processing apparatus 40 arranged for calibration an object within an image data 59 using a marker associated with a measurement of a dimension in pixel units and a calibration routine arranged for calculating a calibration factor from the dimension of the marker in pixel units and a true dimension of the marker. The output of the apparatus 40 preferably comprises an image comprising objects with calibration factors assigned to them. The output of the apparatus 40 is made available to the further input 55 of a viewer 51. Preferably, the further input 55 comprises a suitable processor arranged to operate a suitable interface using a program 56 adapted to control the user interface 54 so that an image 53 comprising suitable object 53a associated with the marker 53a′ and a further object 53b associated with a further marker 53b′ is visualized. Preferably, for user's convenience, the viewer 51 is provided with a high-resolution display 52, the user interface being operable by means of a suitable user interface 57, for example a mouse, a keyboard or any other suitable user's input device. Preferably, the image analysis system 50 further comprises a data acquisition unit 61. However in this example an X-ray device is shown, other data acquisition modalities, like a CT, magnetic resonance apparatus or an ultra-sound device are contemplated as well. The X-ray apparatus is arranged to acquire image data from an object, for example a patient, positioned in an acquisition volume V of the apparatus 61. For this purpose a beam of X-rays (not shown) is emitted from the X-ray source 63. The transmitted radiation (not shown) is registered by a suitable detector (65). In order to enable an oblique imaging, the X-ray source 63 and the X-ray detector 65 are mounted on a gantry 64 which is rotatably connected to a stand 67. A signal S at the output of the X-ray detector 65 is representative of the image data 59.

FIG. 6 presents in a schematic way an embodiment of a workflow of a method according to the invention. At step 74 of the method according to the invention the image data 72a is amended with a suitable plurality of markers. It is possible that before the step 74 a preparatory step 72 is executed, where a suitable image data 72a is loaded into a suitable image processing means. It is possible to delineate markers manually or in a fully automated fashion. In the latter case, preferably, the image is overlaid with a graphic template 74a comprising a suitable plurality of markers linked to a suitable tool for a measurement of dimensions of these markers in pixel units. Preferably, the graphic template is loaded from a suitable database 75. Alternatively, the graphic template 74a may be on-line calculated based on the image data 72a, for example, by creating suitable calibration shapes based on features present in the image. This operation can successfully be implemented using per se known image segmentation techniques. Calibration shapes may be based on anatomical sites, or on other objects, for example professional calibration markers. At step 76 dimensions of all identified markers in pixel units are calculated. These values are forwarded to a suitable calibrator which is arranged to carry out a calibration step in accordance with a relationship, notably a ratio between the dimension of the marker in pixel units and a true dimension of the marker. It is possible that default values of the respective true dimensions of the markers are made available to the calibrator automatically. In this case the respective calibration factors are determined at step 78. Alternatively, the user may be prompted to input true values of the marker's dimensions, the calibration factors being calculated after the user has responded accordingly. When the calibration factor for each identified marker is established, it is automatically applied to the objects linked to each respective marker and conceived to be scaled. This operation is schematically illustrated at step 79. Hereby a first object 80 is selected, which is assigned a length 83 in pixel units, which is coupled to at least one landmark 81 and a marker 80a. Let, for example, a femur head be selected as the object 80. The dimension in pixel units 83 in this case is calculated from a diameter of a circle 81, which is matched to the image of the femur head. It is possible that a plurality of dimensions in pixel units is assigned to one object, this is illustrated by 83, 84. For example, a bone may be characterized by a diameter of a femur head and a thickness of the femur bone itself. When a true dimension of the marker 80a is established, the corresponding calibration factor for the object 80 is determined and is subsequently applied to values 83, 84 to yield respective true dimensions of these parts of the objects 80. This example shows a situation, when a calculation of a dimension in pixel units 84 is based on two landmarks 82, 82b defined in the image. It is also possible that a plurality of objects (not shown) is coupled to a single calibration factor obtained from the same marker. In this case all these objects will be scaled automatically. Upon an event the corresponding dimensions in pixel units of the object or objects to be scaled are established, the calibration factor obtained at step 78 is applied to them. Preferably, this sequence is carried out in a fully automated fashion. In this case at the step 86 the user is prompted to accept the calibration results. For a different object 85a, which has a different orientation is space or a different magnification factor than the object 80, a different marker 85 is assigned. Preferably, the object 85a is defined within a geometric relational application framework macro based on a suitable landmark 85b. The marker 85 is linked to a measurement tool arranged to calculate its dimension in pixel units within the image and to forward this value to the calibration means, which is arranged to calculate and to store a respective calibration factor for this marker based on the dimension in pixel units and a true length of the marker. This calibration factor is linked to the object 85a. In case the user wishes to edit either the true dimension of any of the markers, or their length in pixel units, or the length in pixel units of any of the objects linked to any of the markers, he is returned to the calibration routine at step 87. As follows from the foregoing, according to the method of the invention the user is enabled to carry out an easy and reliable calibration step for a plurality of objects characterized by a plurality of calibration factors, thus improving the accuracy of the image processing and image analysis as a whole.

1. An image processing apparatus (40) arranged to scale an object (3, 8, 9) within an image (1), said image processing apparatus comprising:
a calibrator (45) arranged to scale the object based on a calibration factor derived from a relationship between a true dimension of a marker and a pixel dimension of the marker in the image,
wherein the calibrator is further arranged to generate a plurality of calibration factors obtained using a plurality of differently oriented markers (A, B) identified within said image (1).

2. An image processing apparatus according to claim 1, wherein said apparatus further comprises a linker (47) arranged to form groups each comprising at least one object linked to a respective marker (A, B).

3. An image processing apparatus according to claim 2, wherein said apparatus further comprises a visualizer (47a) arranged to indicate each of said groups independently.

4. An image processing apparatus according to claim 1, wherein the calibrator (45) is further arranged to overlay said image (20) with a graphic template of the marker (29, 37), said graphic template being linked to a measurement tool for measuring of the dimension of the marker in pixel units.

5. An image processing apparatus according to claim 4, wherein the measurement tool is defined within a geometric relational application framework macro.

6. An imaging system (50) comprising an image processing apparatus (40) according to claim 1 and a display (51).

7. An imaging system (50) according to claim 6, further comprising a data acquisition system (61) linked to the image processing apparatus (40).

8. A method for enabling scaling of an object within an image, said method comprising the steps of:
identifying a plurality of differently oriented markers within the image;
for each marker calculating a calibration factor based on a relation between a true dimension of the marker and a dimension of the marker in pixel units;
generating a plurality of the calibration factors.

9. A method according to claim 8, said method further comprising the steps of:
creating calibration groups, each comprising at least one object associated with a corresponding marker;
scaling the objects using the respective calibration factors.

10. A method according to claim 7, wherein for identifying the plurality of markers a graphic template linked to a measurement tool is used.

11. A method according to claim 10, wherein the measurement tool is defined within a geometric relational application framework macro.

12. A method according to claim 11, wherein the geometric relational application framework macro is used to associate a plurality of objects with a marker for each calibration group.

13. A computer program for causing a processor to carry out the steps of the method according to claim 8.
